(19) United States
(12) Patent Application Publication
(10) Pub. No.: US 2006/0157565 A1
(43) Pub. Date: Jul. 20, 2006

(54) Card reader

(76) Inventor: Toshiro Shiomi, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/300,878

(22) Filed: Dec. 14, 2005

(30) Foreign Application Priority Data
Dec. 15, 2004 (JP) 2004-362423

(51) Int. Cl. G06K 7/00

(52) U.S. Cl. 235/440

(57) ABSTRACT

The objective of the invention is to provide a card reader that can prevent a function of performing a card process with respect to a magnetic card and a contact type IC card from becoming out-of-order temporarily and also can contribute to improvement in the speed of various processes including an authentication process and in security. The signal processing circuit having a function of recording or reproducing information with respect to a magnetic card, a contact type IC card, and a contact-less type IC card is provided to a card reader, and this signal processing circuit and a host device are electrically connected to each other via a single host interface.

### CROSS-REFERENCE TO RELATED APPLICATION

This application claims priority of Japanese Application No. 2004-362423, filed Dec. 15, 2004, the complete disclosure of which is hereby incorporated by reference.

a) Field of the Invention

The present invention relates to a card reader which records and reproduces information with respect to a card. Specifically, it relates to a card reader which can record and reproduce information by making contact with a card, and also can record and reproduce information through electromagnetic induction without contacting a card.

b) Description of the Related Art

As conventional cards that are used at banks and also used for cashless use or personal authentication, there are magnetic cards having a magnetic strip on a plastic card surface and IC cards (hereinafter denoted as “contact type IC cards” in this specification) having an integrated circuit chip (IC chip) built into a plastic card and IC terminals arranged on the surface thereof. The recording and/or reproducing of information with respect to those magnetic cards and contact type IC cards are performed by a card reader (including a card reader/writer) which is equipped with a magnetic head and IC contacts.

In recent years a card has been invented into which an IC chip and an antenna coil are built so that the recording or reproducing of information is performed based on the electromagnetic interaction through the antenna coil (hereinafter a card of this type is denoted as “a contact-less type IC card” in this specification). The contact-less type IC card has memory size and security which are equivalent to those of a contact type IC card, and is also superior in operability (a user needs to only hold up the card) and maintenance (there is no contact portion), compared to a magnetic card and a contact type IC card with which a card reader makes contact to communicate data. The recording or reproducing of information with respect to a contact-less type IC card is performed by a card reader (including a card reader/writer) that is equipped with an antenna that generates electromagnetic waves.

Also a card reader has been developed in recent years having a hybrid function that can handle and process all of the above-mentioned cards; the magnetic card, the contact-type IC card, and the contact-less type IC card (see Patent Application 2000-132646 Publication, for example). A card reader described in this reference is equipped with a magnetic head for sending/receiving data to/from a magnetic strip on a magnetic card, IC contacts for sending/receiving data to/from IC contacts on a contact type IC card, and a communication antenna for sending/receiving data to/from an antenna coil on a contact-less type IC card.

FIG. 7 is a block diagram showing a simple electric configuration of a conventional card reader.

In FIG. 7, a conventional card reader 100 has a contact signal processing means 102 which is electrically connected to a host device 101 via a host interface 104 and records or reproduces information by bringing a magnetic head 106 or contact type IC card contacts 107 into contact with a card, a contact-less signal processing means 103 which is electrically connected to the host device 101 via a host interface 105 and records or reproduces information without contacting a card but through electromagnetic induction via an external open-type contact-less communication antenna 109, a magnetic head 106, contact IC card contacts 107, and a SAM (Secure Application Module) socket 108 to which SAM for authenticating a contact-less type IC card is connected. The contact signal processing means 102 consists of a CPU 102a, a magnetic card processing circuit 102b, and a contact IC card processing circuit 102c. The contact-less signal processing means 103 consists of a CPU 103a and a contact-less IC card processing circuit 103b.

In order to respectively process a magnetic card, a contact type IC card and a contact-less type IC card, a conventional card reader 100 is actually equipped with two types of card readers: one for processing magnetic cards and contact type IC cards (that is the contact signal processing means 102) and the other for processing contact-less type IC cards (that is the contact-less signal processing means 103). In addition, the host interfaces (104 and 105) are also mounted corresponding to the types of card reader.

In such a conventional card reader 100, when the contact signal processing means 102 or the contact-less signal processing means 103 is engaged in processing a card, the other means is excluded from processing a card (it will not accept the card). A more specific example is as follows. First, the host device 101 sends an activating command to the contact-less signal processing means 103 via the host interface 105 to determine if the contact-less signal processing means 103 is in a communication state with a contact-less type IC card (i.e., to determine if an appropriate contact-less type IC card is held up over the external open-type contact-less communication antenna 109 and a serial number, etc. of the card is specified and activated). Then, the host device 101 receives the result of the activating command from the contact-less signal processing means 103 via the host interface 105. When it is determined, based on the result, that the contact-less type IC card is activated, the host device 101 sends the contact signal processing means 102 via the host interface 104 a command for prohibiting taking the card in. Accordingly, when the contact-less signal processing means 103 is processing the card, the contact signal processing means 102 is excluded from processing the card.

### DISCLOSURE OF THE INVENTION

a) Problems of the Conventional Invention and Card Reader and Objectives of the Present Invention

However, in the conventional card reader 100, the recording or reproducing of information with respect to a contact-less type IC card sometimes starts before the exclusion process is completed (before the host device 101 sends to the contact signal processing means 102 a command to prohibit taking the card in). The host device 101 is poor at processing a control that requires a high speed response; when it controls multiple devices (contact signal processing means 102 and contact-less signal processing means 103), it sends a command separately via a host interface (104 or 105) corresponding to each device. For this reason, the host device 101 has difficulty with processes other than the recording or reproducing of information with respect to the contact-less type IC card. Consequently, the contact signal processing means 102 enters a temporary out-of-order status.

In particular, for the contact-less type IC card that is held up over the external open-type contact-less communication antenna 109 (see FIG. 7) for recording or reproducing information, the card is held up over the external open-type contact-less communication antenna 109 only for a short period of time. Therefore, the host device 101 needs to determine as quickly as possible if the card reader and the contact-less type IC card are able to communicate; after the host device determines this, the card needs to be processed quickly in the contact-less signal processing means 103. In such a case, it is highly possible that the contact signal processing means 102 may enter a temporary out-of-order status.

Also, in the conventional card reader 100, a SAM process may be adopted for authenticating contact-less type IC cards. In general, even for authenticating a contact-less type IC card, a SAM process is performed by sending/receiving the authentication data to/from a SAM which is connected to the SAM socket 108 (see FIG. 7). Various data including ID data is sent back and forth via the contact signal processing means 102, the host interface 104, the host device 101, the host interface 105, and the contact-less signal processing means 103. Therefore, it has been difficult to improve the contact-less type IC card authenticating process at a higher speed because the process involves the host device 101 which is poor in the control requiring a high speed response. Further, since the authentication data containing data that requires privacy is sent back and forth via the host device 101 with which a human process may intervene, security has not been guaranteed.

The present invention has been invented considering the above problems, and the objective thereof is to provide a card reader that can prevent a temporary out-of-order status of the card processing function with respect to magnetic cards and contact-type IC cards and can contribute to improvements both in speed of various processes including authentication and in security.

### SUMMARY OF THE INVENTION

To achieve the above objectives, the present invention features a card reader provided with a signal processing means having a function that record or reproduce information with respect to magnetic cards, contact type IC cards and contact-less type IC cards, wherein the signal processing means and a host device are electrically connected to each other via a single physical interface.

More specifically, the present invention provides the following features.

(1) A card reader equipped with a signal processing means which has a function of recording or reproducing information by bringing a magnetic head or IC contacts into contact with a card and a function of recording or reproducing information through electromagnetic induction without contacting a card, wherein the signal processing means is electrically connected to a host device through a single physical interface.

According to the present invention, a signal processing means is provided, which has a function of recording or reproducing information by bringing a magnetic head or IC contacts into contact with a card and a function of recording or reproducing information through electromagnetic induction without contacting a card, and the signal processing means and a host device are electrically connected to each other via a single physical interface. Thus, the two above-mentioned functions of the signal processing means of a card reader can be integrated as a single function. Further, in order to control multiple devices, the host device does not need to send a command separately through a host interface corresponding to each device, but can send a command through a single physical interface.

Consequently, after receiving a command through a singe interface, when the signal processing means determines that a contact-less type IC card is activated, it can automatically (not through the host device) perform an exclusion process to prohibit the processing of a magnetic card or a contact type IC card. Therefore, the function of processing a magnetic card or contact type IC card is prevented from even entering a temporary out-of-order status, which is normally caused when the data is sent via the host device which is poor at the control requiring a high speed response.

Further, various data including authentication data is sent back and forth within the signal processing means, not through the host device which is poor at the control requiring a high speed response and with which a human hand may interfere. Therefore, this contributes to a higher processing speed and to the improvement of security.

The “interface” interposed between the host device and the signal processing means can be of any type as long as it is single. It includes all interfaces such as RS232C, USB, serial I/O, parallel I/O, and interface LSI which can be physically connected to the host device based on a predetermined standard.

Note that a “card” having “a function of recording or reproducing information through electromagnetic induction without contacting a card” includes not only a general rectangle shaped card (a cash card, for example) but also ones built into media such as cellular phones, equipped with a contact-less IC chip. In other words, the card reader of the present invention also has a function for recording or reproducing information with respect to a contact-less IC chip built into a cellular phone through electromagnetic induction without contacting the card but.

(2) The card reader as set forth in (1) wherein the signal processing means is equipped with a magnetic card processing portion for recording or reproducing information by bringing the magnetic head into contact with a magnetic strip on a magnetic card, a contact type IC card processing portion for recording or reproducing information by bringing IC contacts into contact with IC terminals arranged on a contact type IC card, and a contact-less type IC card processing portion for recording or reproducing information through electromagnetic induction between a coil built into a contact-less type IC card and a contact-less type communication antenna; with a single command sent from the host device, the signal processing means recognizes the card processing status in the magnetic card processing portion, the contact type IC card processing portion and said contact-less type IC card processing portion.

According to the present invention, the above-mentioned signal processing means is equipped with a magnetic card processing portion for recording or reproducing information by bringing the magnetic head into contact with a magnetic strip on a magnetic card, a contact type IC card processing portion for recording or reproducing information by bringing IC contacts into contact with IC terminals arranged on a contact type IC card, and a contact-less type IC card processing portion for recording or reproducing information through electromagnetic induction between a coil built into a contact-less type IC card and a contact-less type communication antenna; the card processing status of each portion is recognized by the signal processing means, based on a single command that has been sent from the host device. Therefore, the card processing status of each portion can be determined quickly without going through the host device that is not good at the control requiring a high speed response. Consequently the process of recording or reproducing information with respect to a contact-less type IC card that is in an unstable communication environment can be started immediately.

3) The card reader as set forth in (2), wherein the signal processing means further includes a control portion that communicates information respectively with the magnetic card processing portion, the contact type IC card processing portion, and the contact-less type IC card processing portion; according to the card processing status, when either the magnetic card processing portion and the contact-type IC card processing portion or the contact-less type IC card processing portion performs the card processing, the control portion sends to the other card processing portion a control signal that prohibits card processing.

According to the present invention, the signal processing means is provided with a control portion that communicates information respectively with the magnetic card processing portion, the contact type IC card processing portion, and the contact-less type IC card processing portion; according to the card processing status, when either the magnetic card processing portion and the contact-type IC card processing portion or the contact-less type IC card processing portion performs the card processing, the control portion sends to the other card processing portion a control signal that prohibits card processing. Therefore, when it is determined that a contact-less IC card is validated, an exclusion process is given promptly, by which processing of a magnetic card or a contact type IC card is automatically stopped. Consequently, the process of recording or reproducing information with respect to a contact-less type IC card that is in an unstable communication environment can be started more quickly with certainty.

(4) The card reader as set forth in (2) or (3), further having a SAM processing means for authenticating a contact type IC card, wherein the SAM processing means is connected to the contact-type IC card processing portion, and the contact-less type IC card processing portion communicates information with the SAM processing means, not going through a host device, but through the contact type IC card processing portion.

According to the present invention, the above-mentioned card reader is further provided with a SAM processing means for authenticating a contact type IC card; and the SAM processing means is connected to the contact-type IC card processing portion, and the contact-less type IC card processing portion communicates information with the SAM processing means, not going through a host device, but through the contact-type IC card processing portion. Therefore, the authentication data containing data that requires privacy is sent back and forth, not going through the host device with which a human hand may interfere, but within the signal processing means. This contributes to the improvement of security.

As described above, a card reader of the present invention is equipped with a signal processing means that can internally link a function that records or reproduces information by bringing a magnetic head or IC contacts into contact with a card and a function that records or reproduces information through electromagnetic induction without contacting a card; and also the signal processing means is electrically connected with a host device through a single physical interface. Therefore, a card reader of the present invention can prevent a temporary out-of-order status in the card processing function with respect to magnetic cards and contact type IC cards and can contribute to the improvement in speed of various processes including authentication and in security.

The present invention will be described hereinafter referring to the drawings.

### BRIEF DESCRIPTION OF THE DRAWINGS

In the drawings:

FIG. 1 is a block diagram showing an electrical configuration of a card reader of an embodiment form of the present invention;

FIG. 2 is a flowchart showing a basic processing operation of the card reader of the embodiment of the present invention;

FIG. 3 is a response data (response format) of a command to confirm a card take-in status/card activation status;

FIG. 4 is a flow diagram showing a link operation between a contact-less type IC card and SAM in a conventional card reader (see FIG. 7);

FIG. 5 is a flow diagram showing a link operation between a contact-less type IC card and SAM in the card reader of the embodiment form of the present invention (see FIG. 1);

FIG. 6 is a diagram to describe another embodiment form of the present invention; and

FIG. 7 is a block diagram showing an electrical configuration of a conventional card reader.

### DESCRIPTION OF THE PREFERRED EMBODIMENTS

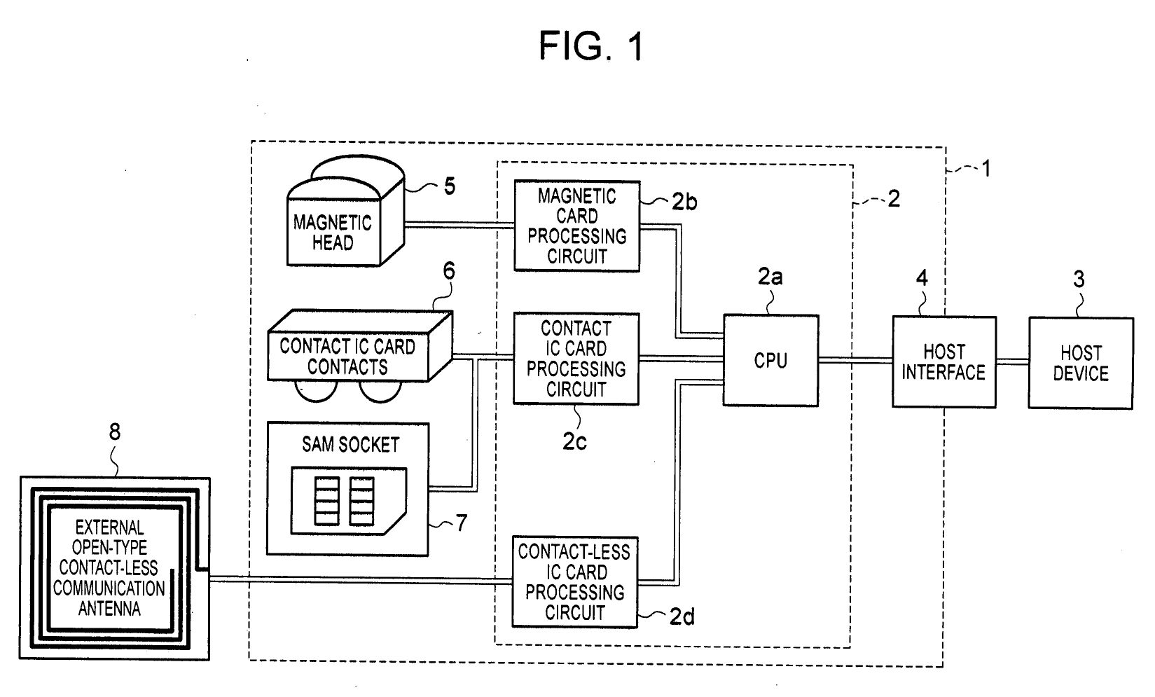

FIG. 1 is a block diagram showing an electrical configuration of a card reader 1 of the present invention.

In FIG. 1, the electrical configuration of a card reader 1 of the present invention comprises a single host interface 4 which is electrically connected to a host device (such as ATM machine, ID authentication terminal, etc.) 3 that commands the card reader 1 for operations, a magnetic head 5 against which a magnetic strip on a magnetic card is slid for read/write communication, contact IC card contacts (IC contacts) 6 that make contact with the IC terminals arranged on a contact type IC card to perform a communication process with respect to the contact type IC card, a SAM socket 7 to which a SAM is connected for card authentication, and a signal processing means 2 that communicates information with the magnetic head 5, the contact IC card contacts 6, and an open-type contact-less communication external antenna 8.

The signal processing means 2 has a magnetic card processing circuit 2b which processes input/output signals with respect to a magnetic card through the magnetic head 5, a contact IC card processing circuit 2c which processes input/output signals with respect to a contact type IC card through the contact IC card contacts 6, a contact-less IC card processing circuit 2d which processes input/output signals with a contact-less type IC card through the open-type contact-less communication external antenna 8, and a CPU 2a which integrally controls the entire card reader 1 including the communication with the host device 3 and the input/output processes with the magnet card processing circuit 2b, contact IC card processing circuit 2c, and contact-less IC card processing circuit 2d.

Note that CPU 2a is a part of or the entire control portion. In other words, ROM or RAM that is electrically connected to CPU2a may be included in the control portion (they are omitted in FIG. 1 for convenience). The external open-type contact-less communication antenna 8 is connected to the contact-less IC card processing circuit 2d with or without a wire such as a lead wire. Further, although a single SAM socket 7 is mounted in FIG. 1, multiple sockets may be mounted.

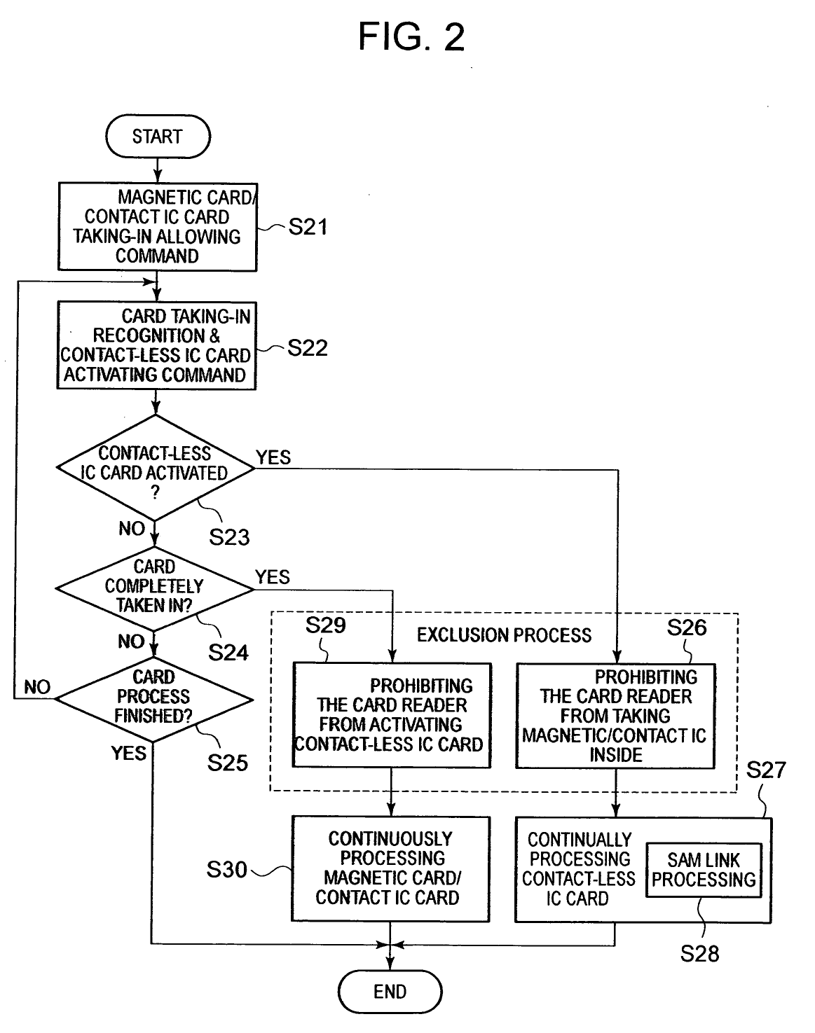

Next, a basic processing operation of the card reader 1 that has the above electrical configuration will be described using FIG. 2.

FIG. 2 is a flowchart showing a basic processing operation of the card reader 1 of the present invention.

In FIG. 2, the host device 3 first issues a command to allow a magnetic card or a contact type IC card to be taken in (Step S21). Then, the CPU 2a of the signal processing means 2 that has received the command sends to the magnetic card processing circuit 2b and the contact IC card processing circuit 2c a control signal regarding the card take-in permission. With this, the magnetic card or the contact type IC card is ready to be taken in.

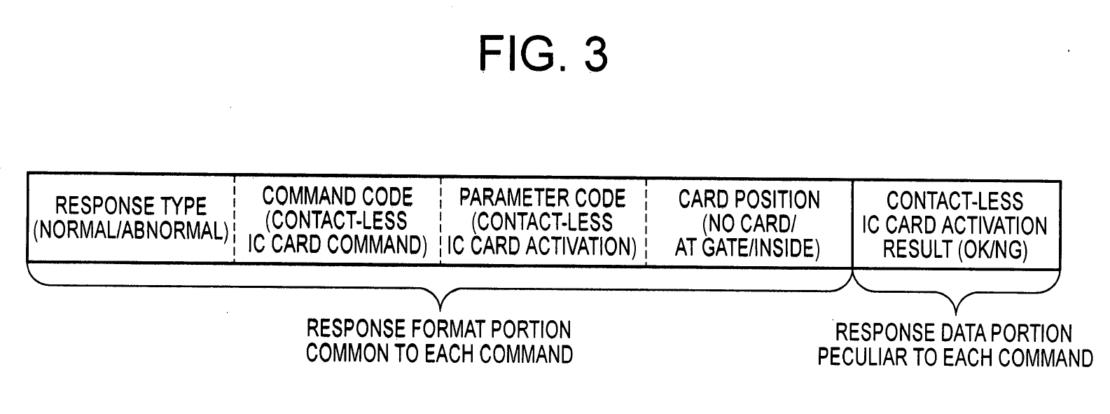

The host device 3 then issues a command that can determine both the card take-in status of the magnetic card and contact type IC card and the activating status of the contact-less type IC card (Step S22). The CPU2a of the signal processing means 2 that has received the command sends a control signal to the magnetic card processing circuit 2b and the contact IC card processing circuit 2c to confirm the card take-in status, and also sends a signal to the contact-less IC card processing circuit 2d to confirm the activating status. As the CPU 2a receives the result of the command execution based on the control signals, it sends the command execution result as the response data to the host device 3. As shown in FIG. 3, the command execution result (the response data) that the host device 3 has received is composed of a response format portion common to all the commands and a response data portion peculiar to each command. The response format portion is composed of a response type (normal/abnormal), a command code (contact-less IC command), a parameter code (contact-less activation), and a card position (no card/at gate/inside); the response data portion is composed of a contact-less activation result (OK/NG).

At this moment, The CPU 2a sends the above-mentioned command execution results as the response data to the host device 3 and also determines, based on the command execution results, if the contact-less type IC card is activated (Step S23) and if the magnetic card or the contact type IC card is completely taken in (Step S24).

When it is determined that the contact-less type IC card is activated or that the magnetic card or the contact type IC card is fully taken in, an exclusion process (inside the dotted line) is performed automatically in the card reader 1. In other words, when the CPU 2a determines that the contact-less type IC card is activated, it sends to the magnetic card processing circuit 2b and the contact IC card processing circuit 2c a control signal that prohibits them from taking the card in (that prohibits card processing) (Step S26). Also, when the CPU 2a determines that the magnetic card or the contact type IC card is fully taken in, it sends to the contact-less IC card processing circuit 2d a control signal that prohibits the card activation (that prohibits card process) (Step S29). In this manner, an automatic exclusion process by the CPU 2a is completed.

When it is determined that the contact-less type IC card is activated, and after the CPU 2a of the signal processing means 2 completes the automatic exclusion process (Step S26), the host device 3 that has received the command execution results (see FIG. 3) as the response data continually performs the card process (the recording or reproducing of information) on the contact-less type IC card (Step S27). On the other hand, when it is determined that the magnetic card or the contact type IC card has been completely taken in, and after the CPU 2a of the signal processing means 2 completes the automatic exclusion process (Step 29), the host device 3 continually performs the card processing (the recording or reproducing of information) on the magnetic card or the contact type IC card (Step S30). As the process of Step S27 or Step 30 is completed, this sub-routine ends.

When it is determined that the contact-less IC card is not activated and the magnetic card or the contact type IC card is not completely taken in, the host device 3 that has received the command execution results (see FIG. 3) as the response data determines whether or not the card processing should be ended (Step S25). When it determines to end the processing, this sub-routine is ended; when it determines to continue the processing, the process goes back to Step S22.

As described above, since CPU 2a of the signal processing means 2 automatically performs an exclusion process, it prevents the function of processing a magnetic card and a contact type IC card from entering a temporary out-or-order status. Also, since various data communications are performed without going through the host device 3 which is weak in the control that requires a high speed response, the processing can be improved at a higher speed.

Next, the link operation of a contact-less type IC card and a SAM is described. In Step S27 of FIG. 2, the host device 3 can command the card reader 1 to perform a link operation between a contact-less type IC card and a SAM (Step S28) if necessary. As the CPU 2a receives the command, it performs a link operation with a SAM in the card reader 1 without reporting the progress to the host device 3, but it will report only the result to the host device.

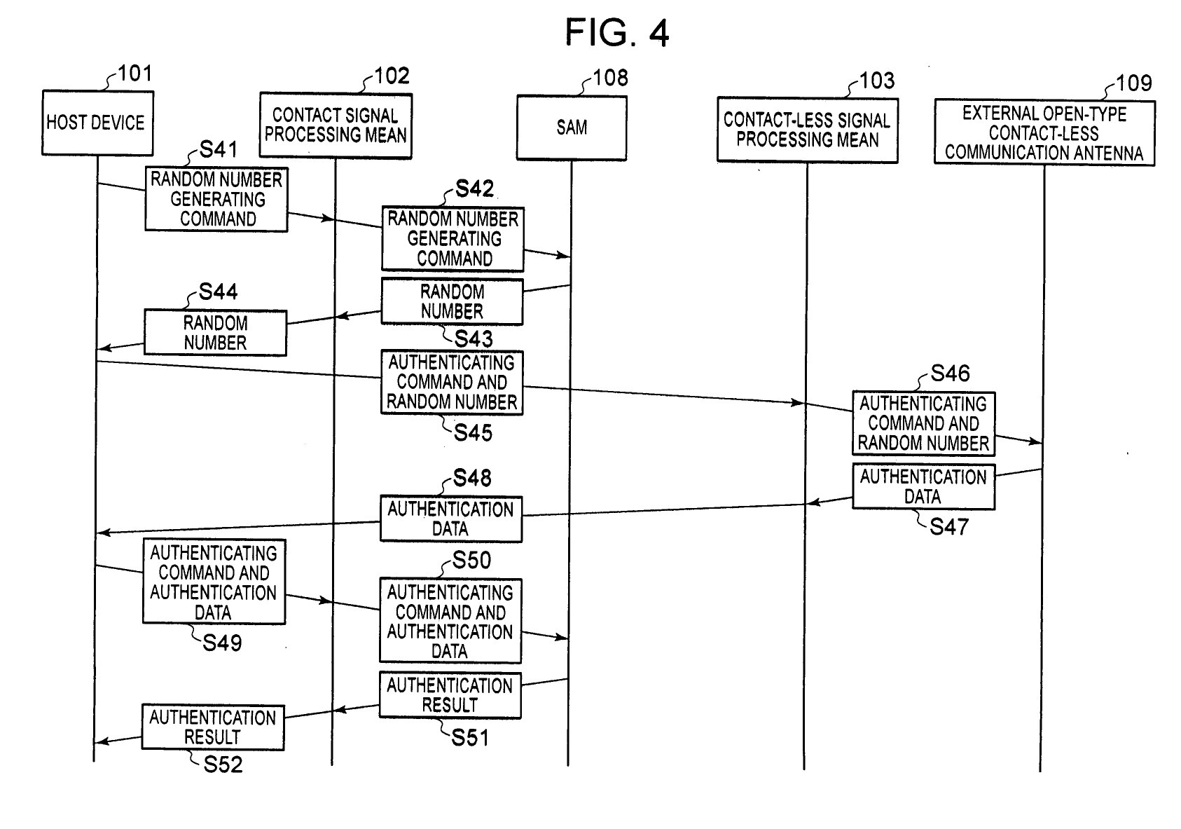

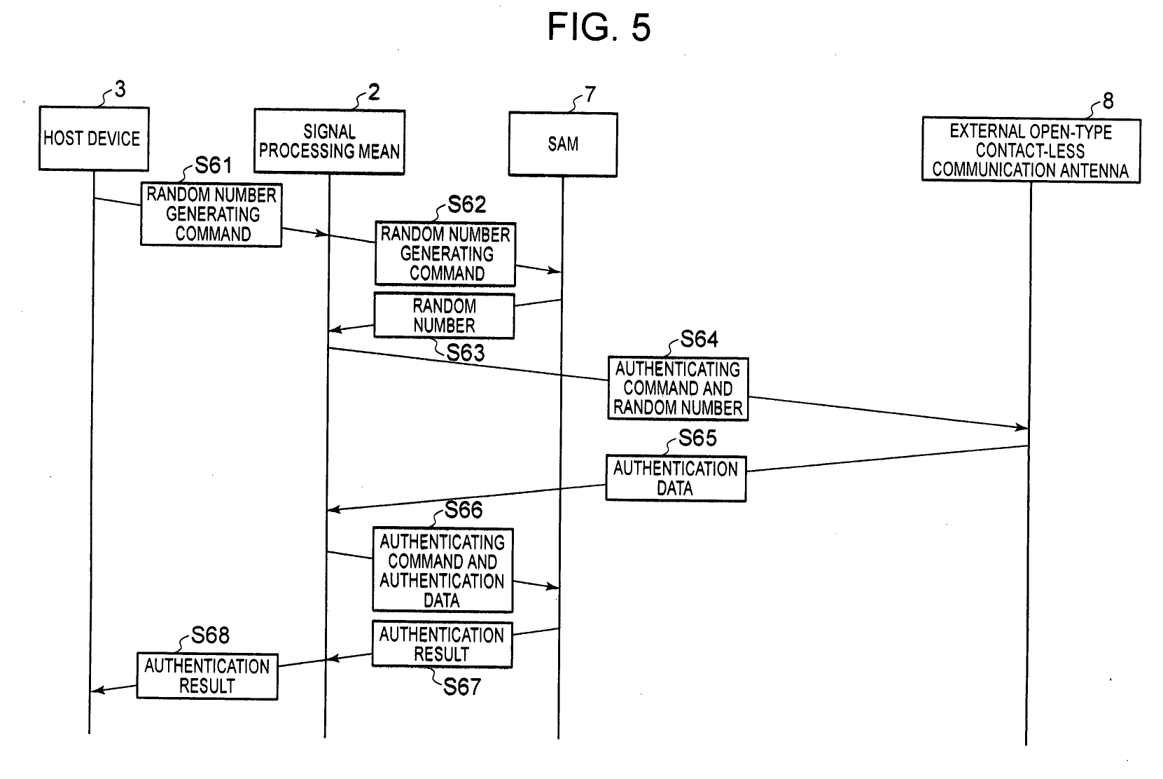

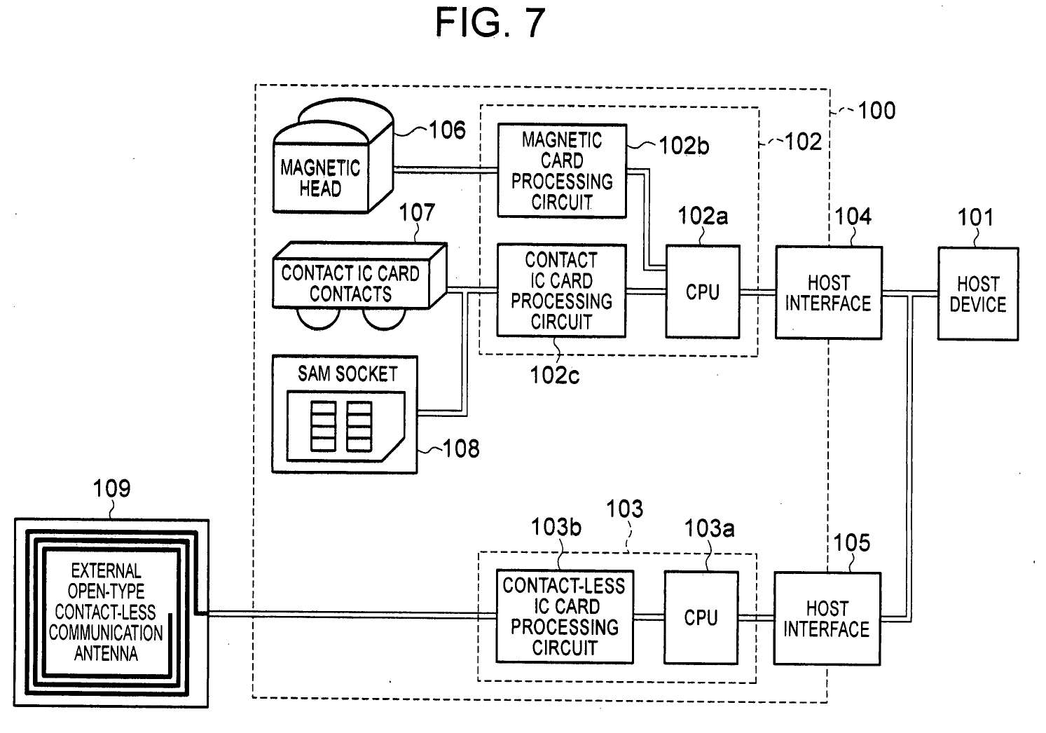

The link operation is described hereinafter using FIG. 4 and FIG. 5. FIG. 4 is a flowchart showing a link operation of a contact-less IC card and a SAM in the conventional card reader 100 (See FIG. 7). FIG. 5 is a flowchart showing the link operation of a contact-less type IC card and a SAM in the card reader of the present invention (see FIG. 1).

In FIG. 4 showing a conventional link operation, the device and means in which data is sent back and forth are a host device 101, a contact signal processing means 102, a SAM connected to a SAM socket 108 (hereinafter denoted as “SAM 108”), a contact-less signal processing means 103 and an external open-type contact-less communication antenna 109 (contact-less type IC card).

First, the host device 101 sends a random number generating command to the contact signal processing means 102 (Step S41); the contact signal processing means 102 that has received the command sends the random number generating command to the SAM 108 (Step S42). Then, a random number to be used for authentication is created in SAM 108 and sent via the contact signal processing means 102 (Step S43) to the host device 101 (Step S44).

Next, the host device 101 sends an authentication data creating command together with the random number that has been received in Step S44 (Step S45). Then, the contact-less signal processing means 103 sends the authentication data creating command and the random number to the external open-type contact-less communication antenna 109 (Step S46). The external open-type contact-less communication antenna 109 sends the authentication data creating command and the random number over the transporting waves (electromagnetic waves) to the contact-less type IC card, and then receives from the contact-less type IC card the authentication data in which the random number is coded by a secret key.

The authentication data is sent via the contact-less signal processing means 103 (Step S47) to the host device 101 (Step S48). Upon receiving the authentication data, the host device 101 sends the authentication data and an authenticating command via the contact signal processing means 102 (Step S49) to SAM 108 (Step S50). SAM 108 decodes the authentication data using the secret key, and sends to the contact signal processing means 102 the authentication result in which the decoded authentication data and the random number are compared to each other (Step S51).

On receiving the authentication result, the contact signal processing means 102 forwards it to the host device 101 (Step S52). Finally, the host device 101 performs the card authentication based on the authentication result it received.

As shown in Steps S44 through S45 and Steps S48 through S49, the link operation between a contact-less type IC card and SAM is performed via the host device 101 in the conventional card reader 100.

On the other hand, FIG. 5 shows a link operation of the present invention in which the device and means for data communication are a host device 3, a signal processing means 2, a SAM connected to a SAM socket 7 (hereinafter denoted as “SAM 7”) and an external open-type contact-less communication antenna 8 (contact-less type IC card).

First, the host device 3 sends a random number generating command to the signal processing means 2 (Step S61), and the signal processing means 2 in turn sends the random number generating command to the SAM 7 (Step S62). Then, a random number to be used for authentication is created in the SAM 7 and sent to the signal processing means 2 (Step S63).

Next, the CPU 2a of the signal processing means 2 sends an authentication data creating command together with the received random number to the external open-type contact-less communication antenna 8 (Step S64). The external open-type contact-less communication antenna 8 sends the authentication data creating command and the random number over the transporting wave (electromagnetic wave) to the contact-less type IC card, and receives from the contact-less type IC card the authentication data in which the random number is coded by a secret key.

The authentication data is sent to the signal processing means 2 (Step S65). Upon receiving the authentication data, the CPU 2a of the signal processing means 2 sends the authentication data and an authenticating command to the SAM 7 (Step S66). The SAM 7 decodes the authentication data using the secret key and sends to the signal processing means 2 the authentication result in which the decoded authentication data and the random number are compared to each other (Step S67).

As receiving the authentication result, the signal processing means 2 forwards the result to the host device 3 (Step S68). Finally, the host device 3 performs the card authentication based on the authentication result it has received.

As shown in Steps S63 through S64 and Steps S65 through S66 in the card reader of the present invention, the authentication that requires privacy is sent back and forth, not going through the host device 3 with which a human hand may interfere, but within the card reader 1, thus contributing to the improvement of security.

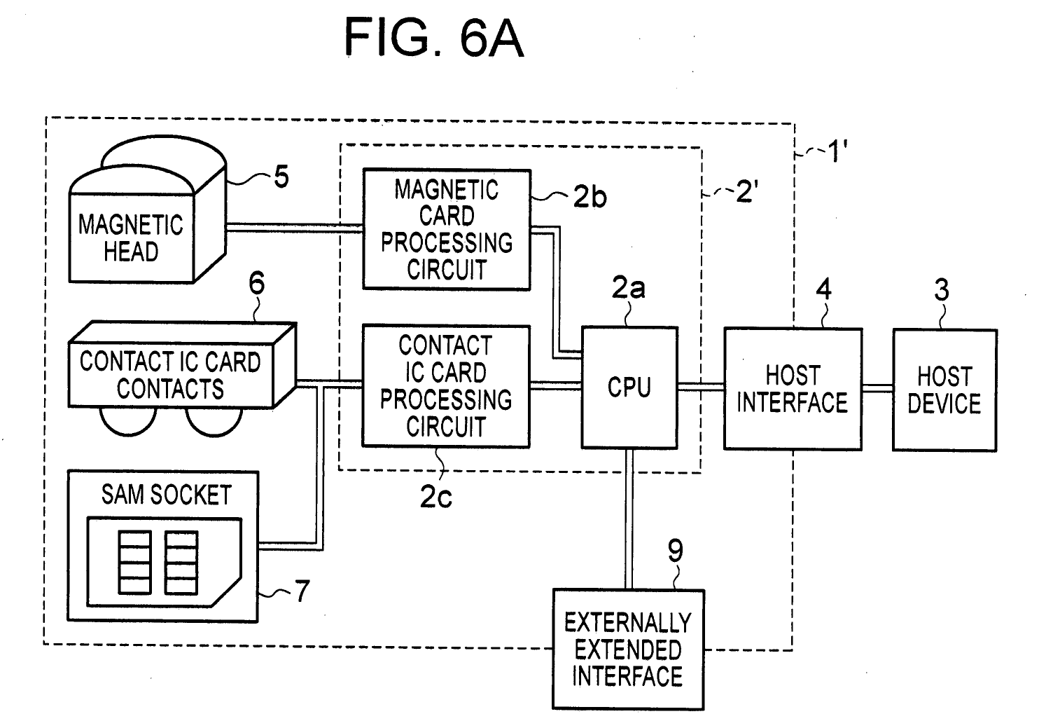

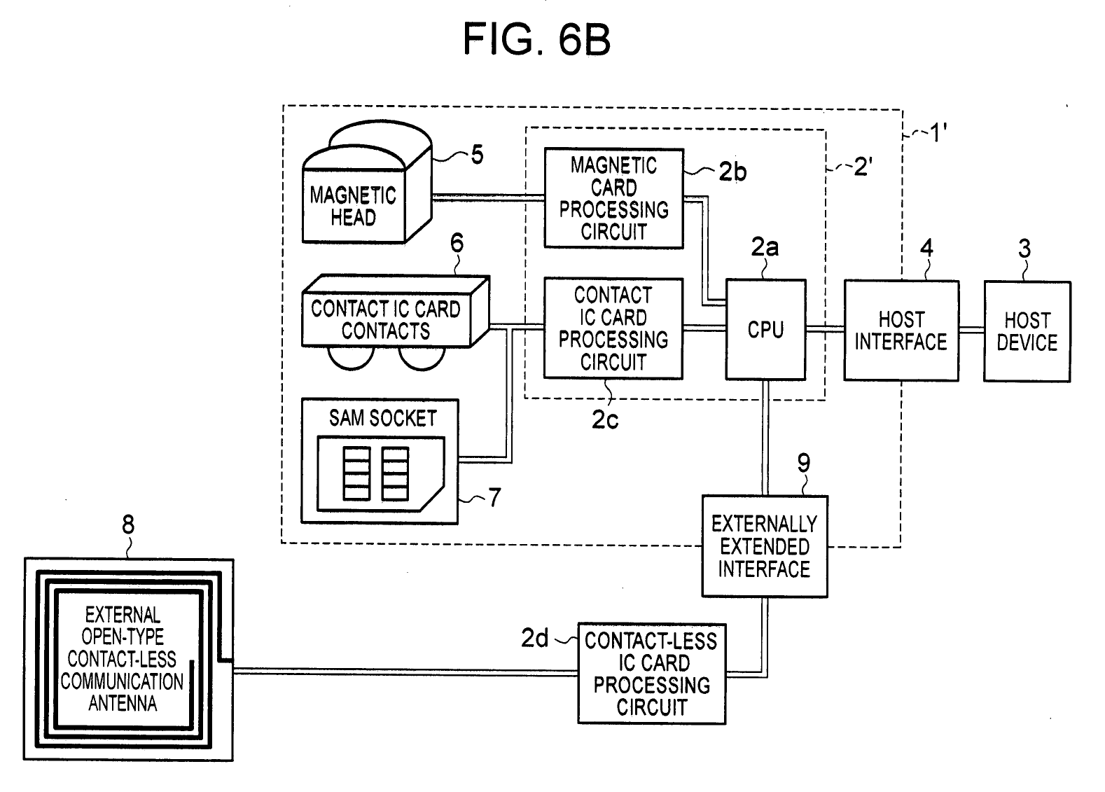

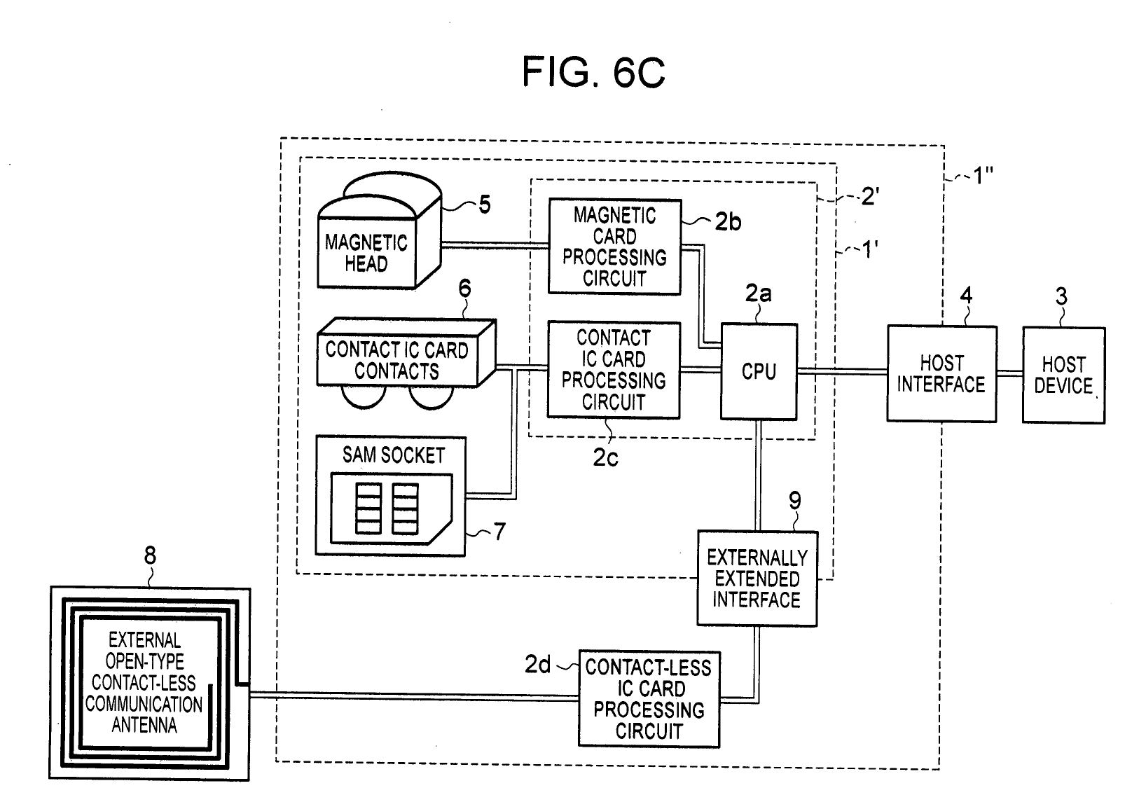

FIG. 6 is a diagram illustrating another embodiment of the present invention. In the embodiment of the present invention shown in FIG. 6, a function of processing contact-less type IC cards is added to a card reader 1′ (see FIG. 6(a)) that has only the function of processing magnetic cards and contact type IC cards; the card reader 1″ that has the additional function (see FIG. 6(c)) functions in the same manner as the above-described card reader 1. Note that the same electrical elements as those in FIG. 1 are similarly designated.

In FIG. 6(a), the card reader 1′ has only a function of processing magnetic cards and contact type IC cards. In other words, the card reader 1′ comprises of a single physical interface 4 which is electrically connected to the host device 3, CPU 2a, a contact signal processing means 2′ configured with a magnetic card processing circuit 2b and a contact IC card processing circuit 2c, a magnetic head 5, contact IC card contacts 6, a SAM socket 7, and an externally extended interface 9. Note that the externally extended interface 9 is, for example, an externally extended SAM interface.

The external open-type contact-less communication antenna 9 is connected to the externally extended interface 9 via the contact-less IC card processing circuit 2d (see FIG. 6(b)). A firmware for the card reader is downloaded from the host device 3 and stored in ROM (not illustrated in FIG. 6) connected to CPU 2a. With this, the card reader 1′ becomes a card reader 1″ to which an additional function of processing contact-less IC cards is provided (see FIG. 6(c)) and can function in the same manner as the above-described card reader 1. Note that CPU 2a, the magnetic card processing circuit 2b, the contact IC card processing circuit 2c, the externally extended interface 9 and the contact-less IC card processing circuit 2d in FIG. 6 correspond to the signal processing means 2 of the card reader 1 (see FIG. 1).

According to the present invention, when a link operation needs to be performed between a magnetic card and contact type IC card and a contact-less IC card, it is possible not to perform an exclusion process but to perform a link operation inside the card reader. With this, the process of the link operation can function at a higher speed, contributing to the improvement of security.

As described above, according to the card reader 1 of the present invention a temporary out-of-order status of the function of processing a magnetic card and a contact type IC card can be prevented and also the speed of various processes including the authentication process can be improved.

In particular, the present invention is advantageous when a contact-less type IC card is of an open-type (a type that records or reproduces information with respect to the external open-type contact-less communication antenna 8 in FIG. 1). More specifically described, the processing of an open-type contact-less IC card needs to be completed while the card is held up over the antenna. Though depending on the processing ability of the card reader, a communicable distance between the antenna and the card has natural limitations due to the physical restriction in the actual mounting of the antenna, various electric wave regulations, and the restriction of radio-electromagnetic field by noise standard. Also, since a general user operates a card to be held up over the antenna, a period of time that the communicable distance is kept between the card and the antenna may also vary from the view point of human engineering. Because of the above-mentioned conditions, an open-type contact-less type IC card needs to be completely processed within several hundred ms for a safe process.

However, in a general device in which the function of a card reader is controlled by a host device, the command communication with the card reader and the command processes need to be done in both the host device and the card reader; therefore, tens of ms are needed for the card reader control. Further, there may be a delay in response depending on the property of the host device, and thus it is not unusual that a simple control by the card reader requires more than 100 ms.

On the other hand, when an exclusion process is performed only within the card reader as in the present invention, there is no command to go through; therefore, the time required for the control, except for the time required for a mechanical operation, is shortened to less than several ms. In addition, because of the hardware control, a highly real-time process is originally equipped. For this reason, the response to the control events also requires only less than several ms.

In contrast to the configuration in which a host device controls multiple devices, the configuration of the present invention in which multiple functions are controlled within the card reader has advantages in responding to the detection that an open-type contact-less type IC card is held up over the antenna and in the process afterwards.

Furthermore, according to the card reader 1 of the present invention, the authentication data that requires privacy is sent back and forth only within the card reader, not going through a host device with which a human hand may interfere; therefore, security may be improved.

Particularly, in a conventional case in which data requiring privacy is communicated between a contact-less type IC card and SAM via a host device (see FIG. 4), the security needs to be guaranteed for two communication paths between the device handling the contact-less type IC card and the host device and between the device handling the SAM and the host device. More specifically, a host device usually uses a general OS (Operating System) due to the convenience in software development in recent years; a tool for monitoring the operation of the software is also common as a software-development tool for the software that is run in such an environment. In other words, when security of the host device is not guaranteed, privacy between a contact-less type IC card and the SAM will be also lost in the same manner. Therefore, full attention needs to be paid to security issues of the host device. This brings disadvantage in the added cost of hardware.

However, according to the present invention, when both a contact-less type IC card and the SAM are processed by a single card reader, the communication is processed without going through a host device; therefore, the security measure can be focused on the card reader. As a result, security can be obtained more easily, contributing to reducing cost.

A card reader of the present invention is electrically connected to a host device through a single physical interface, and a function of recording or reproducing information by bringing a magnetic head or IC contacts into contact with a card and a function of recording or reproducing information through electromagnetic induction without contacting a card can be linked inside the card reader. Therefore, this prevents the function of performing a card process with respect to a magnetic card and a contact type IC card from becoming out-of-control temporarily and contributes to the improvement in speed of various processes including the authentication process and in security.

While the foregoing description and drawings represent the present invention, it will be obvious to those skilled in the art that various changes may be made therein without departing from the true spirit and scope of the present invention.

What is claimed is:

1. A card reader comprising:
a signal processing means for recording or reproducing information by bringing a magnetic head or IC contacts into contact with a card and for recording or reproducing information through electromagnetic induction without contacting a card; and
said signal processing means being electrically connected to a host device through a single physical interface.

2. The card reader as set forth in claim 1, wherein said signal processing means has a magnetic card processing portion for recording or reproducing information by bringing said magnetic head into contact with a magnetic strip on a magnetic card, a contact type IC card processing portion for recording or reproducing information by bringing IC contacts into contact with IC terminals arranged on a contact type IC card, and a contact-less type IC card processing portion for recording or reproducing information through electromagnetic induction between a coil built into a contact-less type IC card and a contact-less communication antenna; and, based on a single command sent from said host device, said signal processing means recognizes the card processing status of said magnetic card processing portion, said contact type IC card processing portion and said contact-less type IC card processing portion.

3. The card reader as set forth in claim 2, wherein said signal processing means further includes a control portion that respectively sends/receives information to/from said magnetic card processing portion, said contact type IC card processing portion, and said contact-less type IC card processing portion; and, according to said card processing status, when either said magnetic card processing portion and said contact type IC card processing portion or said contact-less type IC card processing portion performs the card processing, said control portion sends to the other card processing portion a control signal that prohibits card processing.

4. The card reader as set forth in claim 2, further including a SAM processing means for authenticating a contact type IC card, wherein said SAM processing means is connected to said contact type IC card processing portion, and said contact-less type IC card processing portion communicates information with said SAM processing means, not through a host device, but through said contact type IC card processing portion.
